(19) United States
(12) Patent Application Publication
(10) Pub. No.: US 2026/0018960 A1
(43) Pub. Date: Jan. 15, 2026

(54) MOTOR AND ROTARY DRIVE DEVICE

(71) Applicant: MINEBEA MITSUMI Inc., Kitasaku-gun (JP)

(72) Inventors: Akihiko SUZUKI, Kitasaku-gun (JP); Akira DAIRI, Kitasaku-gun (JP)

(21) Appl. No.: 19/263,778

(22) Filed: Jul. 9, 2025

(30) Foreign Application Priority Data
Jul. 11, 2024 (JP) 2024-111927

(51) Int. Cl. H02K 5/16

(52) U.S. Cl. CPC H02K 5/16

(57) ABSTRACT

A spindle motor includes: a bearing sleeve formed in a tubular shape extending in an axial direction; a case formed in a tubular shape extending in the axial direction and disposed at an outer side in a radial direction orthogonal to the axial direction to be in contact with an outer peripheral surface of the bearing sleeve; and a protruding part provided at at least one of the bearing sleeve and the case in a contact part between the bearing sleeve and the case. The contact part includes a first region intersecting the axial direction. The protruding part is provided at the first region. The bearing sleeve is press-fitted into the case.

### CROSS-REFERENCE TO RELATED APPLICATIONS

This application claims the benefit of priority to Japanese Patent Application Number 2024-111927 filed on July 11, 2024. The entire contents of the above-identified application are hereby incorporated by reference.

### TECHNICAL FIELD

The present disclosure relates to a motor and a rotary drive device.

### BACKGROUND

As a kind of motor, a spindle motor with a rotating shaft is known (for example, JP 2006-200583 A). In this type of spindle motor, the shaft is supported by an inner peripheral surface of a sleeve component having tubular shape press-fitted into a case having tubular shape. Lubricating oil is filled between the sleeve component and the shaft, and the sleeve component serves as a fluid dynamic bearing when the shaft rotates.

An end portion of the sleeve component faces flange portions of a rotor hub and the shaft as rotating components, and thus requires a high surface accuracy. Therefore, the sleeve component is press-fitted into the case and then subjected to a finishing process.

### SUMMARY

In the finishing process, machining oil is used for a portion to be machined. The machining oil may penetrate between the case and the sleeve component and may seep out due to deterioration with age. When the machining oil having seeped out is mixed into the lubricating oil filled between the sleeve component and the shaft via an upper end surface of the sleeve, the lubricating oil may be deteriorated.

An object of the disclosure is to provide a structure less likely to cause machining oil used in finishing a sleeve and a case in a motor to penetrate between the case and the sleeve component.

In order to solve the above problem, a motor includes: a first member formed in a tubular shape extending in an axial direction; a second member formed in a tubular shape extending in the axial direction and disposed at an outer side in a radial direction orthogonal to the axial direction to be in contact with an outer peripheral surface of the first member; and a protruding part provided at at least one of the first member and the second member in a contact part between the first member and the second member. The contact part includes a first region intersecting the axial direction. The protruding part is provided at the first region. The first member is press-fitted into the second member.

According to the disclosure, machining oil used in finishing a sleeve and a case in a motor is less likely to penetrate between the case and the sleeve.

### BRIEF DESCRIPTION OF DRAWINGS

FIG. 1 is a perspective view of a hard disk drive device 1.

FIG. 2 is a partial cross-sectional view of a spindle motor 3.

FIG. 3 is an enlarged view of a part III in FIG. 2.

FIG. 4 is a partial cross-sectional view of a spindle motor 3 according to a modification.

FIG. 5 is an enlarged view of a V part of FIG. 4.

FIG. 6 is a partial cross-sectional view of a spindle motor 3 according to a modification.

FIG. 7 is a partial cross-sectional view of a spindle motor 3 according to a modification.

FIG. 8 is an enlarged view of a part VIII in FIG. 7.

FIG. 9 is a partial cross-sectional view of a spindle motor 3 according to a modification.

FIG. 10 is an enlarged view of an X part of FIG. 9.

### DESCRIPTION OF EMBODIMENTS

Hereinafter, embodiments of the disclosure will be described with reference to the drawings. However, while the embodiments described below are subject to various technically preferable limitations for carrying out the disclosure, the scope of the disclosure is not limited to the following embodiments and illustrated examples.

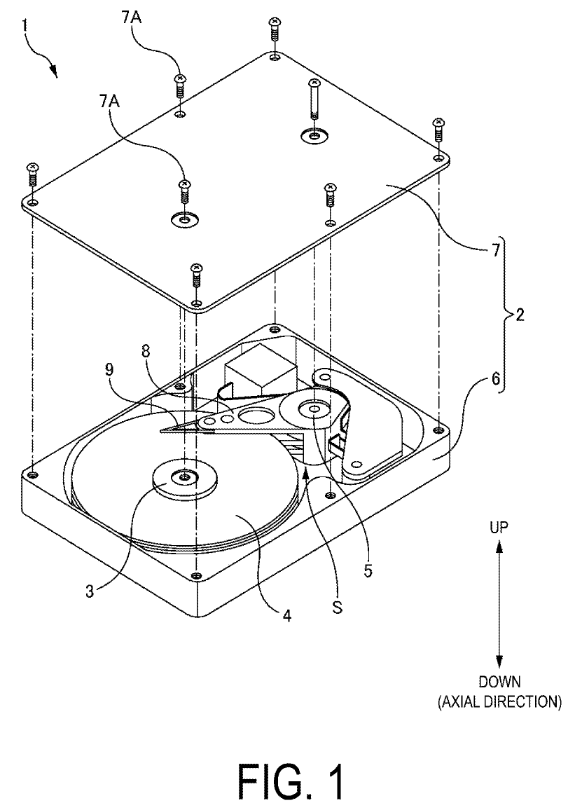

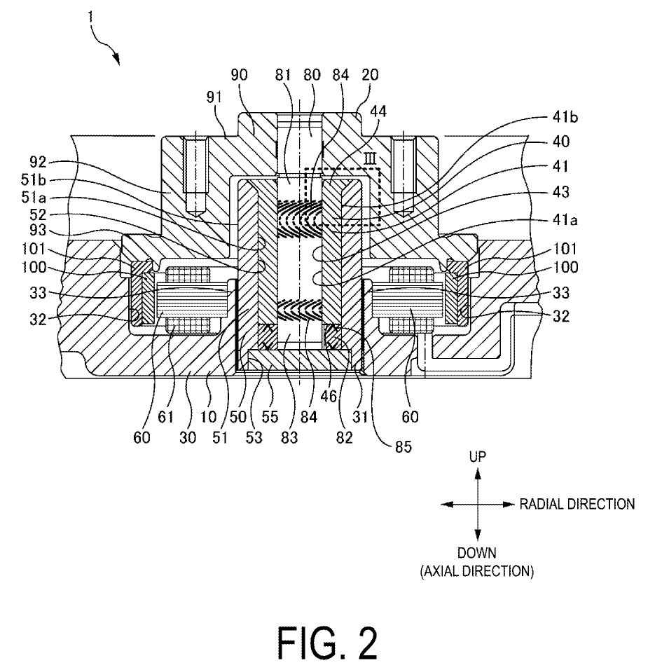

FIG. 1 is a perspective view illustrating a configuration of a hard disk drive device 1. FIG. 2 is a partial cross-sectional view illustrating an example of a spindle motor 3 used for the hard disk drive device 1.

Here, as illustrated in FIG. 2 and the like, a direction parallel to a center axis of a shaft 80 described below is defined as an axial direction, a direction around the center axis of the shaft 80 is defined as a circumferential direction, and a direction perpendicular to the axial direction is defined as a radial direction. For the sake of description, the axial direction is defined as an up-down direction, a rotating part 20 side relative to a stationary part 10 is defined as an upper side, and the stationary part 10 side is defined as a lower side.

### Hard Disk Drive Device

The hard disk drive device 1 (an example of a rotary drive device) includes a housing 2, a spindle motor 3, a recording disk 4, and a bearing device 5.

The housing 2 includes a case 6 and a cover 7. The case 6 has a substantially rectangular parallelepiped bottomed box-like shape with one surface opened. The cover 7 is a plate-shaped member closing the opened surface of the case 6. The cover 7 is fastened to the case 6 by using screws 7A. A sealing part (not illustrated) is provided between the case 6 and the cover 7, and thus the cover 7, together with the case 6, forms the housing 2 having a hermetically sealed interior space S.

The interior space S of the housing 2 is filled with air or helium gas having a density lower than the density of air. Note that the interior space S may be filled with, for example, nitrogen gas or a mixed gas of helium and nitrogen in addition to air or helium gas. The spindle motor 3, the recording disk 4, and the bearing device 5 are accommodated in the interior space S.

The spindle motor 3 (an example of a motor) rotatably supports a plurality of recording disks 4. Note that a detailed structure of the spindle motor 3 will be described below.

The plurality of recording disks 4 are provided and supported by the spindle motor 3 such that respective disk surfaces face one another. Gaps are formed between the respective recording disks 4.

The bearing device 5 swingably supports a plurality of swing arms 8 disposed in the gaps between the respective recording disks 4.

A magnetic head 9 is provided at a tip part of the swing arm 8. The magnetic head 9 imparts magnetism to the recording disk 4 and reads magnetism from the recording disk 4. When the swing arm 8 swings, the magnetic head 9 moves over the recording disk 4.

When the spindle motor 3 rotates, the recording disk 4 also rotates. In this state, when the swing arm 8 swings, the magnetic head 9 moves over the rotating recording disk 4. Then, the magnetic head 9 imparts magnetism to the recording disk 4 and records data to the recording disk 4. Further, the magnetic head 9 reads magnetism from the recording disk 4 and reads out data recorded on the recording disk 4.

### Spindle Motor

Next, a detailed configuration of the spindle motor 3 will be described. FIG. 2 is a partial cross-sectional view illustrating a configuration of the spindle motor 3. The spindle motor 3 includes a stationary part 10 and a rotating part 20 rotating relative to the stationary part 10 through a bearing mechanism.

### Stationary Part

The stationary part 10 includes a base plate 30, a bearing sleeve 40, a case 50, and a stator core 60.

The base plate 30 is a member made of metal. The base plate 30 is formed with a through hole 31, a circumferential groove part 32, and a circumferential wall part 33.

The through hole 31 is a hole for fixing the case 50. The through hole 31 is provided so as to penetrate the base plate 30 in the axial direction. The through hole 31 has a tubular shape, and the inner diameter of the tubular shape is substantially equal to or larger than the outer diameter of the case 50.

The circumferential groove part 32 is formed at an outer side in the radial direction of the through hole 31. The circumferential groove part 32 is an annular groove provided so as to be coaxial with the center axis of the through hole 31 when viewed in the axial direction.

The circumferential wall part 33 is formed as an annular wall surface part protruding upward in the axial direction from the bottom surface of the circumferential groove part 32 when viewed in the axial direction. The diameter of the circumferential wall part 33 is larger than the outer diameter of the through hole 31.

The bearing sleeve 40 (an example of a first member) rotatably supports the shaft 80. The bearing sleeve 40 is a cylindrical member made of brass and extending in the axial direction. The bearing sleeve 40 is machined on the outer peripheral surface. The bearing sleeve 40 includes a main body part 41, a protruding part 42, and a through hole 43.

The main body part 41 is a member having a cylindrical shape extending in the axial direction. The main body part 41 includes an inner peripheral surface 41 a, an outer peripheral surface 41 b, and an upper side end part 44. The inner peripheral surface 41 a faces the shaft 80, and the outer peripheral surface 41b faces the case 50.

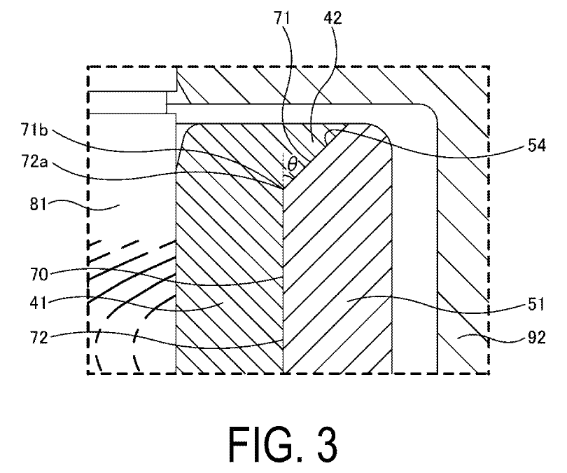

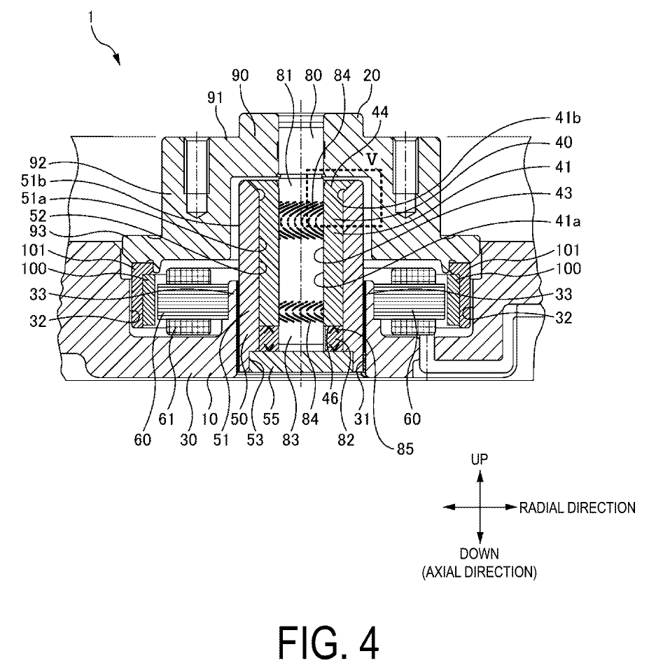

The protruding part 42 is a member provided at an outer side in the radial direction of the main body part 41. As illustrated in FIGS. 3 and 4, the protruding part 42 protrudes outward in the radial direction from the outer peripheral surface of the main body part 41. The protruding part 42 is provided at an outer side in the radial direction of the upper side end part 44 and is provided over the entire circumference in the circumferential direction of the upper side end part 44. The outer diameter of the outer peripheral surface of the protruding part 42 is tapered so as to decrease from the top toward the bottom. A taper angle 0 of the outer diameter of the outer peripheral surface of the protruding part 42 (an angle intersecting the axial direction, see FIG. 3) is preferably 30 degrees or more and 60 degrees or less. The outer peripheral surface of the protruding part 42 may be a flat surface or a curved surface, in addition to the tapered shape.

The through hole 43 is a hole formed at an inner side in the radial direction of the main body part 41. The through hole 43 is formed so as to penetrate the main body part 41 in the axial direction when viewed in the axial direction.

The case 50 (an example of a second member) holds the bearing sleeve 40 and fixes the bearing sleeve 40 to the base plate 30. The case 50 is a cylindrical member made of iron, such as stainless steel, and extending in the axial direction. The case 50 is machined on the outer peripheral surface. The bearing sleeve 40 is press-fitted into the case 50. That is, the case 50 is disposed at an outer side in the radial direction of the bearing sleeve 40. The case 50 includes a case main body part 51, a through hole 52, a lower end recessed part 53, and an upper end recessed part 54.

The case main body part 51 is a cylindrical member extending in the axial direction. The case main body part 51 includes an inner peripheral surface 51 a and an outer peripheral surface Sib. The inner peripheral surface 51 a faces and contacts the outer peripheral surface 41 b of the main body part 41, and the outer peripheral surface 51 b faces the inner peripheral surface of the through hole 31 of the base plate 30.

The through hole 52 is a hole formed at an inner side in the radial direction of the case main body part 51. The through hole 52 is formed so as to penetrate the case main body part 51 in the axial direction when viewed in the axial direction. The bearing sleeve 40 is inserted into the through hole 52. The through hole 52 is continuous with the lower end recessed part 53.

The lower end recessed part 53 is a recessed part provided at a lower side end part of the case main body part 51. The lower end recessed part 53 is a columnar space provided so as to be coaxial with the center axis of the through hole 52 when viewed in the axial direction. The lower end recessed part 53 opens downward. The diameter of the lower end recessed part 53 is larger than the diameter of the through hole 52. A counter plate 55 is attached to the lower end recessed part 53.

The counter plate 55 is a lid having a disk shape and inserted into the lower end recessed part 53 from below the case main body part 5 l. The counter plate 55 closes the lower end recessed part 53.

The upper end recessed part 54 is a recessed part provided at an upper end of the case main body part 51. The upper end recessed part 54 is provided so as to be coaxial with the center axis of the through hole 52 when viewed in the axial direction and is connected to the through hole 52. The inner diameter of the upper end recessed part 54 is tapered so as to decrease from the top toward the bottom at the upper end of the case main body part 51. That is, the inner diameter of the inner peripheral surface of the upper end recessed part 54 is tapered so as to decrease from the top toward the bottom. The taper angle 0 of the inner diameter of the inner peripheral surface of the upper end recessed part 54 (an angle intersecting the axial direction, see FIG. 3) is smaller than the taper angle of the outer diameter of the outer peripheral surface of the protruding part 42. The taper angle of the inner diameter of the inner peripheral surface of the upper end recessed part 54 is preferably 30 degrees or more and 60 degrees or less. Note that the inner peripheral surface of the upper end recessed part 54 may be a flat surface or a curved surface, in addition to the tapered shape.

Here, a relationship between the base plate 30, the bearing sleeve 40, and the case 50 will be described. The bearing sleeve 40 is press-fitted from an upper side in the axial direction of the case main body part 51 such that the outer peripheral surface 41 b of the main body part 41 faces the inner peripheral surface 51a of the case main body part 51. At this time, the bearing sleeve 40 is press-fitted until the outer peripheral surface of the protruding part 42 comes into contact with the upper end recessed part 54 of the case main body part 51. Here, since the taper angle of the inner diameter of the inner peripheral surface of the upper end recessed part 54 is smaller than the taper angle of the outer diameter of the outer peripheral surface of the protruding part 42, the protruding part 42 and the upper end recessed part 54 first come into contact with each other at an outermost portion in the radial direction. When the bearing sleeve 40 is further press-fitted downward, a force pressing the inner peripheral surface of the upper end recessed part 54 in the axial direction by the outer peripheral surface of the protruding part 42 is generated. Therefore, the bearing sleeve 40 is press-fitted into the case 50 while the protruding part 42 is deforming the upper end recessed part 54. As a result, the protruding part 42 and the upper end recessed part 54 form a region where they are in contact with each other from the outer side toward the inner side in the radial direction. In this way, the bearing sleeve 40 and the case 50 are joined to each other.

By press-fitting the bearing sleeve 40 into the case 50, a contact part 70 is formed between these two members. The contact part 70 includes a first region 71 where the protruding part 42 and the upper end recessed part 54 are in contact with each other in a direction intersecting the axial direction, and a second region 72 where the main body part 41 and the case main body part 51 are in contact with each other in the axial direction. The first region 71 and the second region 72 are continuous with each other at a lower end part 71 b of the first region 71 and an upper end part 72a of the second region 72.

In a state where the bearing sleeve 40 is joined to the case 50, the lower end of the main body part 41 is separated upward in the axial direction from the upper surface of the counter plate 55. A shaft flange part 82 of the shaft 80 to be described below is disposed between the lower end of the main body part 41 and the upper surface of the counter plate 55.

In the case of a bearing sleeve and a case having a conventional structure, after the bearing sleeve is press-fitted into the case, the upper and lower end surfaces of the bearing sleeve and the case are subjected to a finishing process (e.g., grinding). Therefore, machining oil used in the finishing process may enter a gap in a joint between the bearing sleeve and the case. However, in the present embodiment, the protruding part 42 of the bearing sleeve 40 presses and deforms the upper end recessed part 54 in the axial direction. Accordingly, the gap in the joint between the protruding part 42 and the upper end recessed part 54 is very small. Therefore, in performing a finishing process on the upper end surfaces of the bearing sleeve 40 and the case 50 using machining oil, the machining oil is less likely to enter the gap in the joint between the protruding part 42 and the upper end recessed part 54.

The case 50 joined with the bearing sleeve 40 is inserted into the through hole 31 such that the outer peripheral surface S1b of the case main body part 51 faces the inner peripheral surface of the through hole 31 of the base plate 30. The case 50 is inserted into the through hole 31 with an adhesive applied to one or both of the outer peripheral surface 51b and the inner peripheral surface of the through hole 31, and fixed to the through hole 31 by the adhesive being cured.

The stator core 60 is a member formed by stacking, in the axial direction, a plurality of electromagnetic steel sheets having an annular shape when viewed in the axial direction. The stator core 60 is disposed inside the circumferential groove part 32 and fixed by a method such as bonding. The stator core 60 has a plurality of pole teeth (protruding poles) extending outward in the radial direction and arranged along the circumferential direction. A coil 61 is wound around the pole teeth. The stator core 60 generates a magnetic flux when a current flows through the coil 61.

### Rotating Part

The rotating part 20 includes the shaft 80, a rotor hub 90, and a rotor magnet 100.

The shaft 80 is a member serving as a rotation axis of the spindle motor 3. The shaft 80 is rotatably supported inside the bearing sleeve 40. The shaft 80 includes a shaft part 81 having a pillar shape and a shaft flange part 82. In the shaft 80, the shaft part 81 and the shaft flange part 82 are integrated with each other.

The shaft part 81 is a columnar shaft member. In the shaft part 81, a shaft end part 83 at the lower side is integrally provided with the shaft flange part 82. The shaft part 81 is disposed inside the bearing sleeve 40 such that the shaft end part 83 provided with the shaft flange part 82 is positioned at the lower side. That is, the outer peripheral surface of the shaft part 81 is surrounded by the inner peripheral surface 41 a of the main body part 41. Then, the outer peripheral surface of the shaft part 81 and the inner peripheral surface 41 a are opposed to each other with a minute gap. Radial dynamic pressure generating grooves 84 are formed at the outer peripheral surface of the shaft part 81.

The radial dynamic pressure generating grooves 84 are provided at the outer peripheral surface of the shaft part 81. In the present embodiment, the radial dynamic pressure generating grooves 84 are formed at the outer peripheral surface of the shaft part 8 l in a continuous row in the circumferential direction, and are formed in two rows with an interval in the axial direction.

The shaft flange part 82 is an annular flange member expanding in the radial direction when viewed in the axial direction. The shaft flange part 82 is joined to the shaft end part 83 and integrated with the shaft part 81. The outer diameter of the shaft flange part 82 is smaller than the inner diameter of the case main body part 51. Thrust dynamic pressure generating grooves 85 are formed at respective upper surface and lower surface of the shaft flange part 82.

The thrust dynamic pressure generating grooves 85 are provided at the upper surface and the lower surface of the shaft flange part 82. The thrust dynamic pressure generating grooves 85 are provided in an annular shape so as to be coaxial with the center axis of the shaft flange part 82 when viewed in the axial direction.

The shaft flange part 82 is disposed between the lower end of the main body part 41 and the upper surface of the counter plate 55 with the shaft 80 supported by the bearing sleeve 40. The upper surface of the shaft flange part 82 is opposed, with a minute gap, to an annular surface 46 as a lower end surface of the main body part 41 in the axial direction. The lower surface of the shaft flange part 82 is opposed to the upper surface of the counter plate 55 with a minute gap. A side surface of the shaft flange part 82 is opposed to the inner peripheral surface 51 a of the case main body part 51 with a minute gap. Since the shaft flange part 82 is disposed between the annular surface 46 and the counter plate 55, the movement of the shaft 80 in the axial direction is prevented.

Lubricating oil is filled between the shaft 80, the bearing sleeve 40, and the case 50. Specifically, the lubricating oil is filled between the outer peripheral surface of the shaft part 81 and the inner peripheral surface 41a of the main body part 41, between the upper surface of the shaft flange part 82 and the annular surface 46, between the lower surface of the shaft flange part 82 and the upper surface of the counter plate 55, and between the side surface of the shaft flange part 82 and the inner peripheral surface 51a of the case main body part 51.

The rotor hub 90 is a member rotating together with the shaft 80. The rotor hub 90 is attached to an upper end of the shaft 80 and is connected with the shaft 80. The rotor hub 90 includes a disk part 91, a cylindrical part 92, and an outer edge part 93.

The disk part 91 is a disk-shaped member formed so as to be coaxial with the center axis of the shaft 80 when viewed in the axial direction. The disk part 91 includes a rotor hub through hole 94. The rotor hub through hole 94 is provided at the center of the disk part 91 when viewed in the axial direction. The disk part 91 is fixed with respect to the shaft 80. Specifically, the upper end of the shaft 80 is inserted into the rotor hub through hole 94 and fixed by a method such as press-fitting or bonding, whereby the disk part 91 is fixed with respect to the shaft 80.

The cylindrical part 92 is a cylindrical member having a thickness in the radial direction. The cylindrical part 92 is provided so as to be coaxial with the center axis of the rotor hub through hole 94 when viewed in the axial direction, and protrudes downward in the axial direction. The cylindrical part 92 is provided at an outer edge of the disk part 9 l. The inner diameter of the cylindrical part 92 is larger than the outer diameter of the bearing sleeve 40. The inner peripheral surface of the cylindrical part 92 is opposed to the outer peripheral surface of the bearing sleeve 40 with a gap.

The outer edge part 93 is an annular member. The outer edge part 93 is provided at the lower end of the cylindrical part 92. The outer edge part 93 protrudes outward in the radial direction from the cylindrical part 92 and is formed in a flange shape. The plurality of recording disks 4 are installed above the outer edge part 93 and at an outer side in the radial direction of the cylindrical part 92 (see FIG. 1).

The rotor magnet 100 is an annular member having a magnetic pole structure magnetized with the polarity inverted to N, S, N, S ... along the circumferential direction when viewed in the axial direction. In the present embodiment, the rotor magnet 100 is attached to an inner peripheral surface of a yoke 101 having an annular shape attached to the lower end of the outer edge part 93. The rotor magnet 100 is located at substantially the same position as the stator core 60 in the axial direction, and is located between the stator core 60 and the inner peripheral surface of the circumferential groove part 32 in the radial direction.

The yoke 101 suppresses leakage of a magnetic flux from the rotor magnet 100. Note that the cylindrical part 92 or the outer edge part 93 may be disposed between the stator core 60 and the inner peripheral surface of the circumferential groove part 32, and the yoke 101 having an annular shape may be attached to the inner peripheral surface of the cylindrical part 92 or the inner peripheral surface of the outer edge part 93. In that case, the rotor magnet 100 is attached to the inner peripheral surface of the yoke 101 so as to be opposed to the stator core 60.

### Operation of Spindle Motor

When the coil 61 is energized, magnetic attractive forces and magnetic repulsive forces generated between the magnetic poles of the rotor magnet 100 and the pole teeth of the stator core 60 are switched. As a result, the rotating part 20 rotates relative to the stationary part 10 using the shaft 80 as the rotation axis.

The shaft 80 rotates relative to the bearing sleeve 40. At this time, the lubricating oil is pressurized by the radial dynamic pressure generating grooves 84, and thus a dynamic pressure is generated in the lubricating oil. By the generated dynamic pressure, the shaft 80 is supported in a non-contact state in the radial direction with respect to the bearing sleeve 40.

The shaft flange part 82 also rotates as the shaft 80 rotates. At this time, the lubricating oil is pressurized by the thrust dynamic pressure generating grooves 85, and thus a dynamic pressure is generated in the lubricating oil. By the generated dynamic pressure, the shaft 80 is supported in a non-contact state in the axial direction with respect to the bearing sleeve 40 and the counter plate 55.

### Modifications

Note that the spindle motor 3 may be a combination of the following changes.

### (1) First Modification

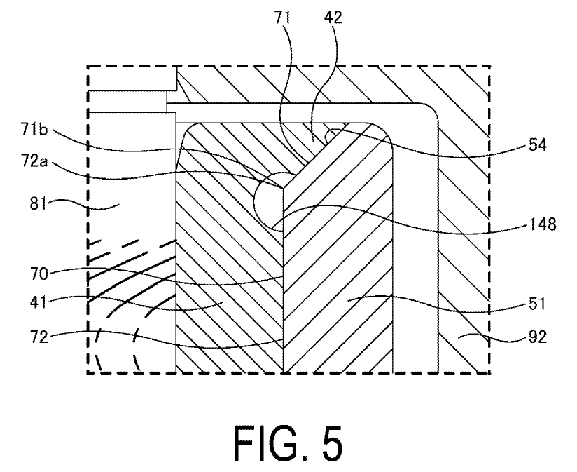

As illustrated in FIGS. 4 and 5, the bearing sleeve 40 may include a recessed part 148.

The recessed part 148 is a recess part provided at the main body part 41. The recessed part 148 is provided at the outer peripheral surface 41b of the main body part 41 so as to extend in the circumferential direction. The recessed part 148 is provided at the contact part 70 with the bearing sleeve 40 press-fitted in the case 50. Specifically, the recessed part 148 is preferably provided at the lower end part 71b of the first region 71 connected to the upper end part 72a of the second region 72. Note that the contact between the bearing sleeve 40 and the case 50 is not necessary at the recessed part 148.

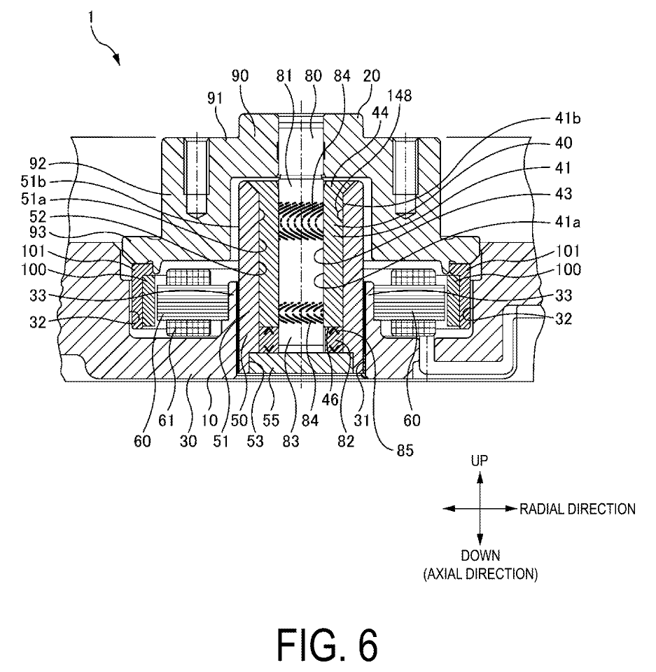

The recessed part 148 may be provided at the first region 71 and the second region 72. FIG. 6 illustrates an example with the recessed part 148 provided at the second region 72. Further, although an example with the recessed part 148 provided at the main body part 41 of the bearing sleeve 40 has been described, the recessed part 148 may be provided at the case 50.

Since the recessed part 148 is provided at the contact part 70, even when the machining oil enters the contact part 70, the machining oil having entered is held in the recessed part 148. Therefore, the machining oil is less likely to seep out to the upper end surfaces of the bearing sleeve 40 and the case 50.

Further, when the recessed part 148 is provided at the part where the protruding part 42 is formed, the bearing sleeve 40 or the case 50, the protruding part 42 is likely to be deformed. Specifically, since the recessed part 148 is provided at the lower end part 71b of the first region 71 connected to the upper end part 72a of the second region 72 (a portion where the first region 71 and the second region 72 are connected with each other), the protruding part 42 is likely to be deformed. As a result, the force of the protruding part 42 pressing the inner peripheral surface of the upper end recessed part 54 in the axial direction increases. Accordingly, the gap in the joint between the protruding part 42 and the upper end recessed part 54 becomes smaller.

### (2) Second Modification

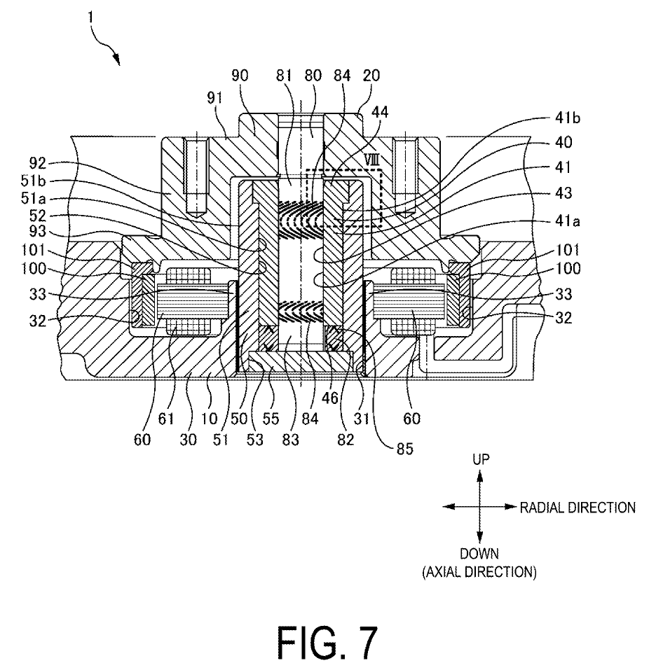

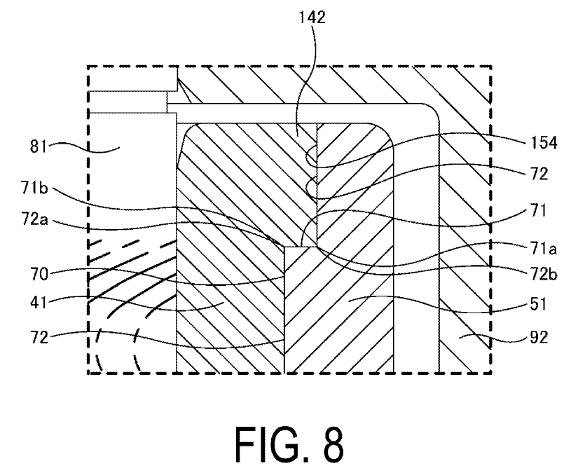

The protruding part 42 and the upper end recessed part 54 may be a protruding part 142 and an upper end recessed part 154, respectively, as illustrated in FIGS. 7 and 8.

The protruding part 142 is a member provided at an upper end and at an outer side in the radial direction of the main body part 41. The protruding part 142 protrudes outward in the radial direction from the outer peripheral surface of the upper side end part 44 of the main body part 41. The protruding part 142 is provided over the entire circumference in the circumferential direction of the upper side end part 44.

The upper end recessed part 154 is a recessed part provided at the upper end of the case main body part 51. The upper end recessed part 154 is a columnar space provided so as to be coaxial with the center axis of the through hole 52 when viewed in the axial direction. The upper end recessed part 154 opens upward. The diameter of the upper end recessed part 154 is larger than the diameter of the through hole 52 and is substantially equal to or smaller than the outer diameter of the protruding part 142. The inner diameter of the inner peripheral surface of the upper end recessed part 154 may be tapered so as to increase from the bottom toward the top. In that case, the inner diameter of the upper end recessed part 154 at the upper end where the inner diameter maximum is substantially equal to or smaller than the outer diameter of the protruding part 142.

Subsequently, a relationship between the bearing sleeve 40 and the case 50 will be described. The bearing sleeve 40 is press-fitted from an upper side in the axial direction of the case main body part 51 such that the outer peripheral surface 41 b of the main body part 41 faces the inner peripheral surface 51 a of the case main body part 51. At this time, press- fitting is performed until the lower surface of the protruding part 142 comes in contact with the bottom surface of the upper end recessed part 154. Here, since the inner diameter of the upper end recessed part 154 is substantially equal to or smaller than the outer diameter of the protruding part 142, the bearing sleeve 40 is press-fitted into the case main body part 51 while the protruding part 142 is deforming the upper end recessed part 154 or while the protruding part 142 is being deformed. Accordingly, the gap in the joint between the protruding part 142 and the upper end recessed part 154 becomes very small. Further, since the lower surface of the protruding part 142 comes into contact with the bottom surface of the upper end recessed part 154, a force pressing the bottom surface of the upper end recessed part 154 in the axial direction by the lower surface of the protruding part 142 is generated. Accordingly, a gap between the lower surface of the protruding part 142 and the bottom surface of the upper end recessed part 154 also becomes very small. In this way, the bearing sleeve 40 and the case 50 are joined to each other.

By press-fitting the bearing sleeve 40 including the protruding part 142 into the case 50 including the upper end recessed part 154, a contact part 70 is formed between these two members. The contact part 70 includes a first region 71 where the bottom surfaces of the protruding part 142 and the upper end recessed part 154 are in contact with each other in a direction intersecting the axial direction, and a second region 72 where the main body part 41 and the case main body part 51 are in contact with each other in the axial direction. The first region 71 and the second region 72 are continuous with each other at an inner end part 71 b of the first region 71 and an upper end part 72a of the second region 72. An outer end part 71a of the first region 71 and a lower end part 72b of the second region 72 are also continuous.

### (3) Third Modification

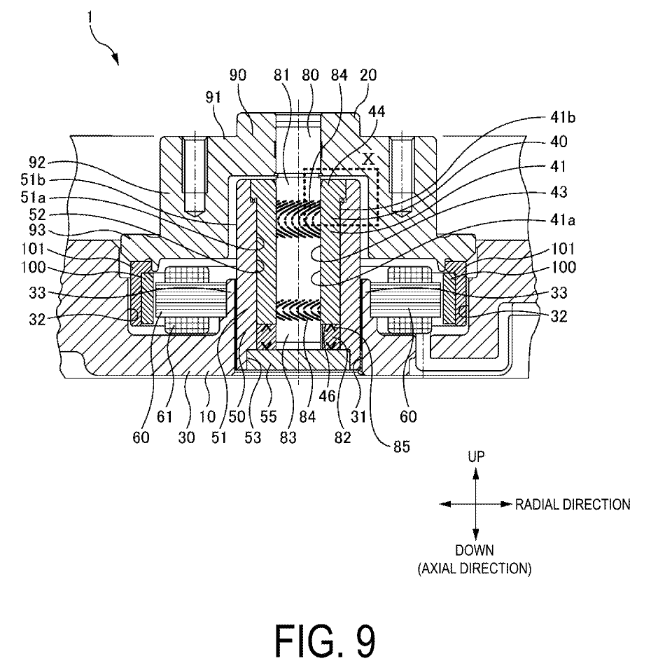

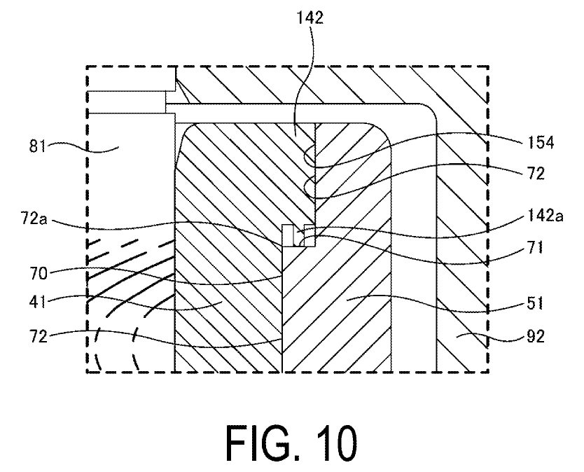

The protruding part 142 described in the second modification may further include an axial direction protruding part 142a as illustrated in FIGS. 9 and 10.

The axial direction protruding part 142a is a member provided at a lower surface of the protruding part 142. The axial direction protruding part 142a protrudes from the lower surface of the protruding part 142 in the axial direction. The axial direction protruding part 142a is provided over the entire circumference in the circumferential direction of the protruding part 142. The length in the axial direction (i.e., the height) of the axial direction protruding part 142a is substantially equal to or longer than a length obtained by subtracting the length in the axial direction of the protruding part 142 from the length in the axial direction of the upper end recessed part 154.

Subsequently, a relationship between the bearing sleeve 40 and the case 50 will be described. The bearing sleeve 40 is press-fitted from an upper side in the axial direction of the case main body part 51 such that the outer peripheral surface 41b of the main body part 41 faces the inner peripheral surface S La of the case main body part 51. At this time, press- fitting is performed until the axial direction protruding part 142a provided at the lower surface of the protruding part 142 comes in contact with the bottom surface of the upper end recessed part 154. Here, since a lower surface of the axial direction protruding part 142a comes into contact with the bottom surface of the upper end recessed part 154, a force pressing the bottom surface of the upper end recessed part 154 in the axial direction by the lower surface of the axial direction protruding part 142a is generated. Accordingly, a gap between the lower surface of the axial direction protruding part 142a and the bottom surface of the upper end recessed part 154 becomes very small. In this way, the bearing sleeve 40 and the case 50 are joined to each other.

By press-fitting the bearing sleeve 40 including the protruding part 142 and the axial direction protruding part 142a into the case 50 including the upper end recessed part 154, a contact part 70 is formed between these two members. The contact part 70 includes a first region 71 where the axial direction protruding part 142a and the upper end recessed part 154 are in contact with each other in a direction intersecting the axial direction, and a second region 72 where the main body part 41 and the case main body part 51 are in contact with each other in the axial direction. In the present modification, the first region 71 and the second region 72 are separated from each other in the radial direction.

### (4) Fourth Modification

The case 50 may have a shape without the upper end recessed part 54 and the upper end recessed part 154. That is, the case main body part 51 is provided with the through hole 52. The inner peripheral surface 51 a formed by providing the through hole 52 at the case main body part 51 may be parallel to the axial direction, or may have a tapered shape increasing or decreasing in inner diameter from one end toward the other end (e.g., the upper end toward the lower end) in the axial direction.

### (5) Fifth Modification

The protruding part 42 of the bearing sleeve 40 press-fitted into the case 50 of the fourth modification may be formed, for example, such that the protruding part 42 is provided from an upper end to a lower end of the case main body part 51 or from the upper end to the vicinity of the lower end. The outer diameter of the protruding part 42 is larger than the maximum diameter of the through hole 52 (the hole diameter at the upper end of the through hole 52). It is conceivable that the outer diameter of the outer peripheral surface of the protruding part 42 is tapered so as to decrease from the top toward the bottom. In that case, the minimum diameter of the outer diameter of the outer peripheral surface of the protruding part 42 (the outer diameter at the lower end) is larger than the maximum diameter of the through hole 52.

### (6) Sixth Modification

In press-fitting the bearing sleeve 40 into the case 50, an adhesive may be used in combination. For example, the bearing sleeve 40 may be press-fitted into the case 50 with an adhesive applied to one or both of the outer peripheral surface 41b of the bearing sleeve 40 and the inner peripheral surface 51 a of the case 50. By press-fitting the bearing sleeve 40 into the case 50 in this way, an adhesive layer is formed at the contact part 70.

### (7) Seventh Modification

In all of the embodiments and the modifications described above, an example where the protruding part is provided at the bearing sleeve 40 and the recessed part paired with the protruding part is provided at the case 50 has been described. The protruding part only needs to be provided at at least one of the bearing sleeve 40 and the case 50. Therefore, the protruding part may be provided at the case 50, and the recessed part paired with the protruding part may be provided at the bearing sleeve 40.

### (8) Eighth Modification

In all of the embodiments and the modifications described above, an example of the hard disk drive device 1 including the spindle motor 3 has been described. The motor is not limited to the spindle motor 3, and the above-described configuration may be applied to any motor. The rotary drive device is not limited to the hard disk drive device 1, and the above- described motor may be applied to any rotary drive device such as a blower, a light detection and ranging (LiDAR) sensor, or a projector.

### Effects

Aspect 1: The spindle motor 3 according to the present embodiment includes: the bearing sleeve 40 formed in a tubular shape extending in the axial direction; the case 50 formed in a tubular shape extending in the axial direction and disposed at an outer side in the radial direction orthogonal to the axial direction to be in contact with the outer peripheral surface 41b of the bearing sleeve 40; and the protruding part 42 provided at at least one of the bearing sleeve 40 and the case 50 in the contact part 70 between the bearing sleeve 40 and the case 50. The contact part 70 includes the first region 71 intersecting the axial direction. The protruding part 42 is provided at the first region 71. The bearing sleeve 40 is press-fitted into the case 50.

According to the spindle motor 3 described above, the bearing sleeve 40 is press-fitted into the case 50, and the protruding part 42 of the bearing sleeve 40 is provided at the first region 71 intersecting the axial direction in the contact part 70 between the bearing sleeve 40 and the case 50, so that the protruding part 42 presses the case 50 in the axial direction. Therefore, a gap in the contact part 70 between the bearing sleeve 40 and the case 50 is very small. As a result, when the upper end surfaces of the bearing sleeve 40 and the case 50 are subjected to a finishing process using machining oil, the machining oil is less likely to enter the gap in the contact part 70. That is, according to the above-described aspect, machining oil used during a finishing process of a sleeve and a case in a motor is less likely to penetrate between components of the case and the sleeve.

Further, according to the spindle motor 3 of the above-described aspect, since the machining oil used for the finishing process is less likely to enter the gap in the contact part 70, the frequency of seeping out of the machining oil having entered the gap in the contact part 70 is also reduced. Therefore, the machining oil is less likely to be mixed into lubricating oil for a fluid dynamic bearing filled between the bearing sleeve 40 and the shaft 80. As a result, the lubricating oil is less likely to deteriorate, and the life of the spindle motor 3 can be extended.

Aspect 2: In Aspect 1, the first member is the bearing sleeve 40, and the second member is the case 50.

According to the spindle motor 3 described above, the machining oil used for the finishing process of the bearing sleeve 40 and the case 50 is less likely to enter the gap in the contact part 70.

Aspect 3: In Aspect 1 or 2, the contact part 70 is a portion where the outer peripheral surface 41b and the inner peripheral surface 51aof the case 50 are in contact with each other, and, in the first region 71, the outer diameter of the outer peripheral surface 41b and the inner diameter of the inner peripheral surface 51a are tapered to decrease toward one side in the axial direction.

According to the spindle motor 3 described above, since the outer diameter of the outer peripheral surface 41b and the inner diameter of the inner peripheral surface 51 a are tapered so as to decrease toward the one side in the axial direction, the lower surface of the protruding part 42 of the bearing sleeve 40 is pressed against the inner peripheral surface 51 a of the case 50. Therefore, the gap in the contact part 70 between the bearing sleeve 40 and the case 50 is very small.

Aspect 4: In Aspect 3, the taper angles of the outer peripheral surface 41b and the inner peripheral surface 51a are 30 degrees or more and 60 degrees or less.

According to the spindle motor 3 described above, since the taper angles of the outer peripheral surface 41b and the inner peripheral surface 51a are 30 degrees or more and 60 degrees or less, the lower surface of the protruding part 42 of the bearing sleeve 40 is likely to be pressed against the inner peripheral surface 51a of the case 50. Therefore, the gap in the contact part 70 between the bearing sleeve 40 and the case 50 is very small.

Aspect 5: In Aspect 3 or 4, the contact part 70 further includes the second region parallel to the axial direction, the recessed part 148 provided at at least one of the bearing sleeve 40 and the case 50 is further included in the contact part 70, the lower end part 71b of the first region 71 is connected to the upper end part 72a of the second region 72, and the recessed part 148 is provided at the lower end part 71b.

According to the spindle motor 3 described above, since the recessed part 148 is provided at the lower end part 71b of the first region 71 where the first region 71 and the second region 72 are connected to each other, the protruding part 42 is likely to deform. As a result, the force of the protruding part 42 pressing the inner peripheral surface of the upper end recessed part 54 in the axial direction increases, and thus the gap in the contact part 70 between the bearing sleeve 40 and the case 50 becomes smaller.

Aspect 6: In Aspect 1 or 2, in the contact part 70 between the bearing sleeve 40 and the case 50, the recessed part 148 provided at at least one of the bearing sleeve 40 and the case 50 is further included.

According to the spindle motor 3 described above, since the recessed part 148 is provided at the contact part 70, even when the machining oil enters the contact part 70 during the finishing process, the machining oil having entered is held in the recessed part 148. Therefore, the machining oil is less likely to seep out to the upper end surfaces of the bearing sleeve 40 and the case 50.

Aspect 7: In any one of Aspects 1 to 6, the contact part 70 includes an adhesive layer.

According to the spindle motor 3 described above, since the contact part 70 includes the adhesive layer, a gap between the outer peripheral surface 41b of the bearing sleeve 40 and the inner peripheral surface 51a of the case 50 at the contact part is very small. Therefore, the machining oil used for the finishing process of the bearing sleeve 40 and the case 50 is less likely to enter the gap in the contact part 70.

Aspect 8: The hard disk drive device 1 includes the spindle motor 3 according to any one of Aspects 1 to 7.

According to the hard disk drive device 1 described above, the lubricating oil for the fluid dynamic bearing used in the spindle motor 3 is less likely to deteriorate, and the life of the spindle motor 3 is long. Therefore, the life of the hard disk drive device 1 is extended.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A motor comprising: a first member formed in a tubular shape extending in an axial direction; a second member formed in a tubular shape extending in the axial direction and disposed at an outer side in a radial direction orthogonal to the axial direction to be in contact with an outer peripheral surface of the first member; and a protruding part provided at at least one of the first member and the second member in a contact part between the first member and the second member, the contact part including a first region intersecting the axial direction, the protruding part being provided at the first region, and the first member being press-fitted into the second member.

2. The motor according to claim 1, wherein the first member is a sleeve, and the second member is a case.

3. The motor according to claim 1, wherein the contact part is a portion where the outer peripheral surface and an inner peripheral surface of the second member are in contact with each other, and in the first region, an outer diameter of the outer peripheral surface and an inner diameter of the inner peripheral surface are tapered to decrease toward one side in the axial direction.

4. The motor according to claim 3, wherein taper angles of the outer peripheral surface and the inner peripheral surface are 30 degrees or more and 60 degrees or less.

5. The motor according to claim 3, wherein the contact part further includes a second region parallel to the axial direction, the motor further includes a recessed part provided at at least one of the first member and the second member in the contact part, an end part of the first region at one side in the axial direction is connected to an end part of the second region at the other side in the axial direction, and the recessed part is provided at the end part at the one side.

6. The motor according to claim 2, wherein the protruding part is provided at the sleeve,
the case includes an upper end recessed part to be in contact with the protruding part of the sleeve and an inner peripheral surface to be in contact with the outer peripheral surface of the sleeve, and
a recessed part is provided at the sleeve,
in the radial direction, the recessed part is facing an end of the upper recessed part which is closer in the axial direction to the inner peripheral surface of the case.

7. The motor according to claim 1, further comprising a recessed part provided at at least one of the first member and the second member in the contact part.

8. The motor according to claim 1, wherein the contact part includes an adhesive layer.

9. A rotary drive device comprising the motor according to claim 1.
